(19) United States
(12) Patent Application Publication
(10) Pub. No.: US 2005/0175118 A1
(43) Pub. Date: Aug. 11, 2005

(54) Data carrier comprising means for influencing the slope course of the signal edges in an amplitude-modulated signal

(75) Inventor: Ewald Bergler, Weiz (AT)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/517,745

(22) PCT Filed: May 16, 2003
(86) PCT No.: PCT/IB03/02059

(30) Foreign Application Priority Data
Jun. 10, 2002 (EP) 02100684.6

(51) Int. Cl. H04L 27/04

(52) U.S. Cl. 375/295

(57) ABSTRACT

Provided in a data carrier (1) designed to modulate a carrier signal (CS) that can be received in a contactless manner are transmission means (2) designed to transmit the carrier signal (CS), and a data signal source (9) designed to generate and emit a data signal (DS), and modulation means (11), which modulation means (11) is designed to receive the data signal (DS) and, using the data signal (DS), to modulate the carrier signal (CS) occurring at the transmission means (2) and to generate an amplitude-modulated signal (S), which amplitude-modulated signal (S) has signal edges (SL), wherein, in addition, signal-edge influencing means (12) is provided, which is designed to influence the slope characteristic of the signal edges (SL) in the amplitude-modulated signal (S).

The invention relates to a data carrier, which is designed to modulate a carrier signal that can be received in a contactless manner, and which is equipped with transmission means designed to transmit the carrier signal, and which is equipped with an electrical circuit, which circuit is equipped with at least one terminal, to which terminal the transmission means are connected and via which terminal the carrier signal can be fed to the circuit, and which circuit is equipped with a data signal source designed to generate and emit a data signal, and which circuit is equipped with modulation means designed to receive the data signal and, using the data signal, to modulate the carrier signal occurring at the at least one terminal, and to generate an amplitude-modulated signal, in which amplitude-modulated signal signal edges occur.

The invention further relates to a circuit for a data carrier which is designed to modulate a carrier signal that can be received in a contactless manner, and which is equipped with transmission means to transmit the carrier signal, which circuit is equipped with at least one terminal, to which terminal the transmission means can be connected, and via which terminal the carrier signal can be fed to the circuit, and which circuit is equipped with a data signal source designed to generate and emit a data signal, and which circuit is equipped with modulation means designed to receive the data signal and, using the data signal, to modulate the carrier signal occurring at the at least one terminal, and to generate an amplitude-modulated signal, in which amplitude-modulated signal signal edges occur.

A data carrier of this kind, of the generic type mentioned in the first paragraph above, and a circuit of this kind, of the generic type mentioned in the second paragraph above, are known from document U.S. Pat. No. 5,345,231. In the known data carrier, which is equipped with the known circuit and which is designed to communicate, in a contactless manner, with a read/write station using a carrier signal emitted by the read/write station, transmission means are provided, with the aid of which the carrier signal can be transmitted to a terminal of the circuit. The data carrier is further equipped with a microcomputer realizing a data signal source, which microcomputer is designed to generate and emit a digital data signal, which data signal represents an item of information to be communicated. Also provided are modulation means, which are coupled with the terminal and which, using the data signal, effect amplitude modulation, specifically in this case what is known as load modulation, of the carrier signal occurring at the terminal, wherein, in accordance with the digital signal fed to the modulation means, the signal edges occurring in the amplitude-modulated signal have a virtually infinitely steep slope since a virtually surge-like signal edge characteristic and therefore a spike-type slope characteristic of the signal edges is present.

In the known data carrier, the problem exists that the steepness of the edges in the amplitude-modulated signal causes a relatively broad spectral distribution in the spectrum of the amplitude-modulated signal, i.e. many unwanted, powerful sidebands occur, which sidebands of the amplitude-modulated signal are frequently incompatible with official regulations, which regulations regulate the spectral distribution of the amplitude-modulated signal.

It is an object of the invention to eliminate the above-mentioned problems in a data carrier of the generic type mentioned in the first paragraph above, and in a circuit of the generic type mentioned in the second paragraph above, and to create an improved data carrier and an improved circuit.

In order to achieve the above-mentioned object, signal-edge influencing means designed to influence the slope characteristic of the signal edges in the amplitude-modulated signal are provided in accordance with the invention in a data carrier of the generic type mentioned in the first paragraph above.

In order to achieve the above-mentioned object, signal-edge influencing means designed to influence the slope characteristic of the signal edges in the amplitude-modulated signal are provided in accordance with the invention in a circuit of the generic type mentioned in the second paragraph above.

Through the provision of measures in accordance with the invention, it is achieved in an advantageous manner that the spectrum of the amplitude-modulated signal caused by modulation of the carrier signal can be influenced in the simplest possible manner to the effect that surge-like signal edge characteristics in the amplitude-modulated signal are prevented, and that, advantageously, only signal transitions with rounded characteristics occur, and, as a result, a continuous slope characteristic of the signal edges occurs, with the result that no powerful sidebands with an interfering, undesirably high energy content occur, so that compatibility with the official regulations in force is virtually always achievable in a reliable manner.

In the solutions in accordance with the invention, signal-edge influencing means may, for example, be realized with the aid of a voltage ramp generator upstream of the modulation means, which voltage ramp generator is designed to influence the signal edges of the data signal, so that no surge-like signal edges with a virtually infinitely steep slope occur in the influenced data signal fed to the modulation means. Furthermore, in the solutions in accordance with the invention, the signal-edge influencing means may, for instance, be realized with the aid of a current ramp generator downstream of the modulation means, which current ramp generator is designed to generate suitable current ramps in a modulation current occasioned by the modulation means. It has, however, proved particularly advantageous if the signal-edge influencing means are realized by filtration means. In this manner, a very simple influencing of the signal edges of the load-modulated signal is enabled with especially simple means, as a result of which advantageous signal-edge characteristics are contained in the amplitude-modulated signal, bringing about an advantageously restricted spectral distribution in the amplitude-modulated signal.

In the solutions in accordance with the invention, the filtration means may, for example, be provided between the modulation means and the transmission means and designed to filter a current occasioned by the modulation means. It has, however, proved particularly advantageous if the filtration means are provided between the data signal source and the modulation means, and designed to filter the data signal that can be emitted from the data signal source to the modulation means. This gives rise to the advantage that a design that can be realized very simply in terms of circuit technology is enabled, since, in this case, the filtration of the data signal realized by means of a voltage signal is undertaken, which can be realized relatively unproblematically in terms of technology and relatively cost-effectively.

In the solutions in accordance with the invention, the filtration means may, for example, be realized by a bandstop filter or by a bandpass filter. It has, however, proved particularly advantageous if the filtration means are formed by a low-pass filter. This gives rise to the advantage that high-frequency sidebands that have proved interfering as regards official regulations can be virtually completely prevented, and that an overshoot at a start or an end of influenced signal edges of the amplitude-modulated signal can also be effectively suppressed.

The above-cited aspects and further aspects of the invention are explained below.

The invention will be further described with reference to examples of embodiments shown in the drawings, to which, however, the invention is not restricted.

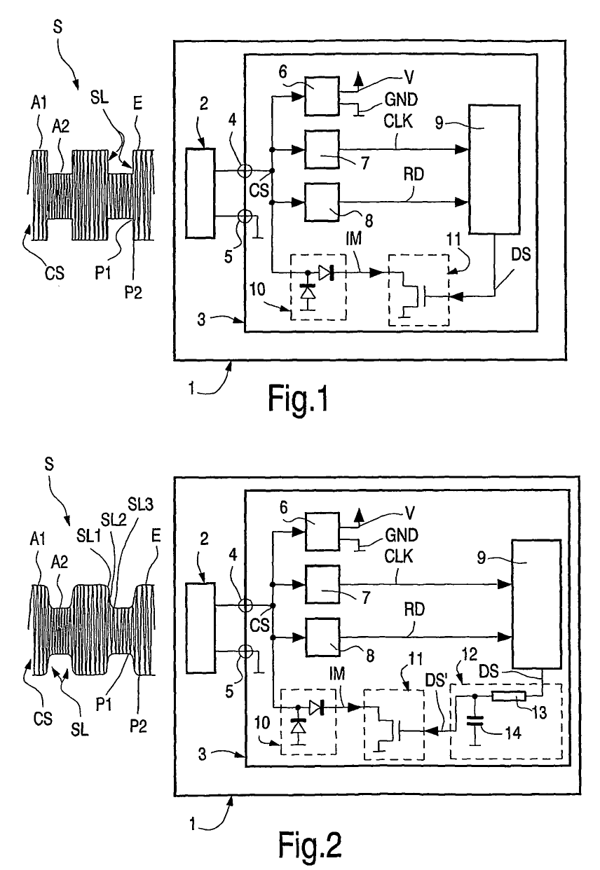

FIG. 1 shows in a schematic manner, in the form of a block circuit diagram, a data carrier in accordance with the prior art.

FIG. 2 shows, in a manner analogous to FIG. 1, a data carrier in accordance with a first embodiment example of the invention.

FIG. 1 shows a known data carrier 1, which is designed to demodulate and modulate a carrier signal CS, either modulated or unmodulated, which can be received in a contactless manner and is also shown in FIG. 1. For the purpose of receiving carrier signal CS, data carrier 1 is equipped with transmission means 2, which is designed for transmitting carrier signal CS and which is realized with the aid of a communication coil configuration not shown in FIG. 1. The communication coil configuration serves for creating an inductive coupling with a read/write station designed for this purpose, which is designed to generate and emit carrier signal CS.

Data carrier 1 is further equipped with an electrical circuit 3, which is realized as an integrated circuit, and which is equipped with a first terminal 4 and a second terminal 5, to which two terminals 4 and 5 the transmission means 2 is connected. Carrier signal CS can be fed to circuit 3 via the first terminal 4. In circuit 3, the second terminal 5 is connected to a reference potential GND of circuit 3. Circuit 3 is further equipped with a voltage generation means 6, which is designed to receive the carrier signal CS, which can be fed to the first terminal 4, and which, using the received carrier signal CS, is designed to generate and to emit a supply voltage V with respect to the reference potential GND for the purpose of supplying circuit 3 with electrical power.

Circuit 3 is further equipped with a clock signal generation means 7, which is designed to receive the carrier signal CS, which can be fed via the first terminal 4. Using the received carrier signal CS, clock signal generation means 7 is further designed to derive a clock signal CLK from carrier signal CS and to emit the clock signal CLK.

Circuit 3 is further equipped with demodulation means 8, which is designed to receive modulated carrier signal CS, which can be fed via the first terminal 4, and to demodulate carrier signal CS. In the event that reception data RD is contained in demodulated carrier signal CS, demodulation means 8 is further designed to emit reception data RD as a result of the demodulation.

Circuit 3 is further equipped with a data signal source 9, which is realized with the aid of a microcomputer, which is designed to receive clock signal CLK and to receive reception data RD. With the aid of clock signal CLK, data signal source 9 is designed for the stepwise processing of program steps of a program, wherein, with the aid of the program, a data signal can be generated, either taking into account reception data RD or not taking into account reception data RD—depending on the processing status—, and emitted from data signal source 9. Data signal DS is digital in nature and, accordingly, essentially has either a first voltage value corresponding to the reference potential GND or a second voltage value corresponding to the supply voltage V, wherein, between these two voltage values, surge-like data signal edges occur so that an essentially spike-like slope characteristic of these signal edges occurs.

The electrical circuit is further equipped with decoupling means 10 and modulation means 11, wherein the decoupling means 10 is connected between the first terminal 4 and the modulation means 11. Decoupling means 10 is realized with a diode configuration, which is designed to decouple the voltage generation means 6 and the clock-signal generation means 7 and the demodulation means 8 from the modulation means 11.

Modulation means 11 is designed to receive data signal DS and, using data signal DS, to modulate the unmodulated carrier signal CS occurring at the first terminal 4, and to generate an amplitude-modulated, specifically in this case load-modulated, signal S. Modulation means 11 is realized with a field effect transistor, to the gate terminal of which data signal DS can be fed. The source terminal of the field effect transistor is connected to the reference potential GND. The field effect transistor is further connected, via its drain terminal, to the decoupling means 10. Using data signal DS, the field effect transistor can be controlled into a conductive state and a blocking state, wherein, in its conductive state, a modulation current IM, determined by its channel resistance, can flow via decoupling means 10 towards reference potential GND, which modulation current IM effects a loading of the unmodulated carrier signal CS, as a result of which a load-modulated signal S, shown in FIG. 1, can be generated. Accordingly, depending on the state of the field effect transistor, signal S has either a first amplitude A1 or a second amplitude A2, which amplitudes A1 and A2 of the load-modulated signal S are determined, in respect of their time of occurrence, by the characteristic of data signal DS in terms of time. Accordingly, load-modulated signal S also has signal edges SL, which occur on a transition from the first amplitude A1 to the second amplitude A2, or on a transition from the second amplitude A2 to the first amplitude Al wherein the signal edges SL occur in a virtually surge-like way, and consequently, by analogy with data signal DS, a spike-type slope characteristic of the signal edges SL is present. A first signal-edge limitation point P1 and a second signal-edge limitation point P2 hereby occur virtually simultaneously. The two amplitudes A1 and A2 of carrier signal CS and the signal edges SL form an envelope curve E of load-modulated signal S.

Data carrier 1 in accordance with the invention, as shown in FIG. 2, is equipped with circuit 3 and the transmission means 2 connected to circuit 3. Circuit 3 of data carrier 1 in accordance with the invention is further equipped with voltage generation means 6 and clock-signal generation means 7 and demodulation means 8 and data signal source 9 and modulation means 11 and decoupling means 10.

Provided in data carrier 1 in accordance with the invention is signal-edge influencing means 12, which is designed to influence the slope characteristic of signal edges SL in load-modulated signal S. The signal-edge influencing means 12 is realized by filtration means, which filtration means is formed by a low-pass filter. The low-pass filter is equipped with a resistor 13, which is connected between data signal source 9 and the gate terminal of the field effect transistor of modulation means 11. The low-pass filter is further equipped with a capacitor 14 connected between the gate terminal of the field effect transistor and the reference potential GND. Accordingly, the filtration means is provided between data signal source 9 and modulation means 11, and is designed to filter the data signal DS emitted from data signal source 9 to modulation means 11. As a result of the filtration, the filtration means is designed to generate a filtered data signal DS and to emit this filtered data signal DS to modulation means 11. The filtration means is dimensioned in such a way that an item of information represented by data signal DS, which can be communicated with the aid of load-modulated signal S from data carrier 1 to the read/write station, can be recognized without problems in the load-modulated signal S at the read/write station because, with the aid of the filtration means, the time period when the two amplitudes, A1 and A2 respectively, are present in load-modulated signal S is influenced to only an insignificant extent. The filtration means is further dimensioned in such a way that a surge-like signal-edge characteristic of signal edges SL is prevented in a reliable manner in load-modulated signal S, and that the signal-edge characteristic is characterized by transitions with rounded characteristics between the two amplitudes A1 and A2. The signal-edge characteristic of one of the signal edges SL of load-modulated signal S extends accordingly between the two signal-edge limitation points P1 and P2, separated from one another in terms of time. Between these signal-edge limitation points P1 and P2, the signal-edge characteristic of signal edge SL is characterized essentially by a first signal-edge section SL1 and a second signal-edge section SL2 and a third signal-edge section SL3, wherein, within the first signal-edge section SL1 and within the third signal-edge section SL3, a relatively severe change to the slope characteristic exists, and wherein, within the second signal-edge section SL2, a change to the slope characteristic that is smaller in comparison with the first signal-edge section SL1 and the third signal-edge section SL3 exists. This gives rise to the advantage that, in load-modulated signal S, it is not spike-type slope characteristics that occur, but essentially dome-shaped slope characteristics that are present, so no powerful sidebands with an interfering, undesirably high energy content occur.

It may be mentioned that an antenna configuration may also be provided in data carrier 1 for realization of transmission means 2, and that the modulation means, by changing an input resistance of the electrical circuit, may be designed to generate a reflection-modulated signal S, wherein, in this case, the modulation of the amplitude of carrier signal CS is retained by changing the input resistance as compared with the resistor of the antenna configuration between a matched and a non-matched state.

It may be further mentioned that the signal-edge influencing means 12 may be realized with the aid of data signal source 9 and with the aid of filtration means, wherein the data signal source may in this case be designed to emit a pulse-width-modulated data signal DS, and the filtration means may be designed to filter the pulse-width-modulated data signal DS and to generate the filtered data signal DS representing the pulse-width-modulated data signal DS, which filtered data signal DS is used for amplitude modulation of a carrier signal CS.

It may be mentioned that the filtration means may also be realized with the aid of a digital signal processor, which gives rise to the advantage that the filtration characteristic of the filtration means may be changed or adapted to the particular circumstances even during operation of the data carrier, by programming the signal processor.

It may be further mentioned that the filtration means may also be realized by an active second or higher order filter, which gives rise to the advantage that the spectrum of the amplitude-modulated signal can be influenced significantly more precisely than is the case with a first-order filter.

It may be further mentioned that the filtration means may also be realized by a filter based on a switchable capacitance, which gives rise to the advantage that a filter characteristic of the filter can be changed in the simplest possible manner, namely by a frequency of switching pulses to switch the capacitance.

1. A data carrier, which is designed to modulate a carrier signal that can be received in a contactless manner, and
which is equipped with transmission means, designed to transmit the carrier signal, and
which is equipped with an electrical circuit,
which circuit is equipped with at least one terminal, to which terminal the transmission means is connected and via which terminal the carrier signal can be fed to the circuit, and
which circuit is equipped with a data signal source designed to generate and emit a data signal, and
which circuit is equipped with modulation means designed to receive the data signal and, using the data signal, to modulate the carrier signal occurring at the at least one terminal, and to generate an amplitude-modulated signal, in which amplitude-modulated signal signal edges occur,
characterized in that signal-edge influencing means provided, which is designed to influence the slope characteristic of the signal edges in the amplitude-modulated signal.

2. A data carrier as claimed in claim 1, characterized in that the signal-edge influencing means is realized by filtration means.

3. A data carrier as claimed in claim 2, characterized in that the filtration means is provided between the data signal source and the modulation means and designed to filter the data signal that can be emitted from the data signal source to the modulation means.

4. A data carrier as claimed in claim 2, characterized in that the filtration means is formed by a low-pass filter.

5. A circuit for a data carrier which is designed to modulate a carrier signal that can be received in a contactless manner, and which is equipped with transmission means to transmit the carrier signal, which circuit is equipped with at least one terminal, to which terminal the transmission means can be connected, and via which terminal the carrier signal can be fed to the circuit, and
which circuit is equipped with a data signal source designed to generate and emit a data signal, and
which circuit is equipped with modulation means designed to receive the data signal and, using the data signal, to modulate the carrier signal occurring at the at least one terminal, and to generate an amplitude-modulated signal, in which amplitude-modulated signal signal edges occur,
characterized in that signal-edge influencing means is provided, which is designed to influence the slope characteristic of the signal edges in the amplitude-modulated signal.

6. A circuit as claimed in claim 5, characterized in that the signal-edge influencing means is realized by filtration means.

7. A circuit as claimed in claim 6, characterized in that the filtration means is provided between the data signal source and the modulation means and designed to filter the data signal that can be emitted from the data signal source to the modulation means.

8. A circuit as claimed in claim 6, characterized in that the filtration means is formed by a low-pass filter.

9. A circuit as claimed in claim 1, characterized in that the circuit is realized as an integrated circuit.
